(19) United States
(12) Patent Application Publication
(10) Pub. No.: US 2006/0267494 A1
(43) Pub. Date: Nov. 30, 2006

(54) Plasma processing device

(75) Inventors: Yasumitsu Tomita, Handa-Shi (JP); Yutaka Unno, Handa-Shi (JP)

Correspondence Address: BURR & BROWN, PO BOX 7068, SYRACUSE, NY, 13261-7068, US

(73) Assignee: NGK Insulators, Ltd., Nagoya-Shi (JP)

(21) Appl. No.: 11/439,655

(22) Filed: May 24, 2006

Related U.S. Application Data
(60) Provisional application No. 60/685,853, filed on May 31, 2005.

(51) Int. Cl. H01J 61/24

(52) U.S. Cl. 313/547

(57) ABSTRACT

To provide a plasma processing device in which an amount of heat generated from a power supply member is small when the power supply member is supplied with high frequency current. A substrate heater as the plasma processing device includes a ceramic base including a high frequency electrode and a high frequency electrode power supply member supplying high frequency current to the high frequency electrode. The high frequency electrode power supply member includes a power supply body and a high conductivity metal layer which is formed on the outer peripheral surface of the power supply body and has a conductivity higher than that of the power supply body.

### CROSS REFERENCE TO RELATED APPLICATION

This application is based upon and claims the benefit of priority from prior U.S. Provisional Application No. 60/685,853, filed on May 31, 2005; the entire contents of which are incorporated herein by reference.

### BACKGROUND OF THE INVENTION

1. Field of the Invention

The present invention relates to a plasma processing device.

2. Description of the Related Art

In conventional semiconductor or liquid crystal manufacturing processes, a plasma processing device is used. The plasma processing device includes a power supply member supplying high frequency current to a RF electrode (high frequency electrode), for example, a Ni rod which is a metal conductor (for example, see the Japanese Patent Laid-open publication No. 11-26192).

When high frequency voltage is applied to the power supply member, because of the skin effect, current is concentrated in surface part of the power supply member (for example, a range from the surface of the power supply member to a depth of several to several tens micrometers thereof), and very little current flows through radial center part of the power supply member.

Resistance of the power supply member is expressed by the following equation (1). However, as described above, since very little current flows through the radial center part of the power supply member because of the skin effect, apparent cross-sectional area S is reduced, and resistance R is increased.

(1) R=L/σS (R: resistance, L: length of the power supply member, σ: conductivity, S: cross-sectional area)

On the other hand, an amount of heat generated by the power supply member is expressed by the following equation (2). As the resistance R is increased, the amount of heat generated is increased.

(2) W=RI² (W: amount of heat generated, R: resistance, I: current)

As described above, with the power supply member in the conventional plasma processing device, the amount of heat generated by the power supply member was increased by the increase in resistance due to the skin effect, which could accelerate degradation of the power supply member itself. Moreover, the heat generation by the power supply member could damage peripheral members disposed in the vicinity of the power supply member. Furthermore, an increase in resistance of the power supply member due to the degradation of the power supply member could increase impedance of the plasma processing device and prevent plasma from being normally generated.

### SUMMARY OF THE INVENTION

An object of the present invention is to provide a plasma processing device in which an amount of heat generated from a power supply member is reduced when high frequency current is applied to the power supply member.

In order to achieve the above object, a plasma processing device according to the present invention includes: a base including an electrode and a power supply member supplying high frequency current to the electrode. Herein, the power supply member includes a power supply body and a high conductivity metal layer which is formed on a surface side in the power supply body and includes a conductivity higher than that of the power supply body.

With the plasma processing device according to the present invention, the power supply member includes the high conductivity metal layer. Accordingly, when high frequency voltage is applied to the power supply member, part of current flowing through surface part of the power supply body flows through the high conductivity metal layer. This can reduce the resistance of the surface part of the power supply member when the high frequency voltage is applied to the power supply member, thus considerably reducing the amount of heat generated from the power supply member.

### BRIEF DESCRIPTION OF THE DRAWINGS

FIG. 1 is a perspective view of a power supply member according to a first embodiment of the present invention.

FIG. 2 is a perspective view showing the power supply member of FIG. 1 with upper part of a high conductivity metal layer omitted.

FIG. 3 is a perspective view of a power supply member according to a second embodiment of the present invention.

FIG. 4 is a perspective view showing the power supply member of FIG. 3 with upper part of a high conductivity metal layer and an diffusion preventing metal layer omitted.

FIG. 5 is a perspective view showing a substrate heater which is a plasma processing device according to a third embodiment of the present invention.

### DETAILED DESCRIPTION OF THE EMBODIMENTS

Hereinafter, a description is given of embodiments of the present invention.

[First Embodiment]

First, a first embodiment of the present invention is described. In this embodiment, the description is given of a power supply member with a high conductivity metal layer formed in an outer peripheral surface (on the surface side) of a power supply body.

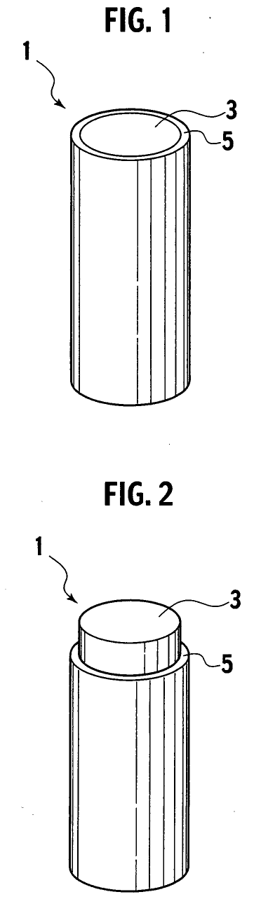

FIG. 1 is a perspective view of a power supply member according to the first embodiment of the present invention, and FIG. 2 is a perspective view showing the power supply member of FIG. 1 with upper part of a high conductivity metal layer omitted.

As shown in FIGS. 1 and 2, the power supply member 1 is formed into a rod (an elongated solid cylinder) extending in the vertical direction in the drawings. The power supply member 1 includes an operation of supplying high frequency current to a high frequency electrode which generates plasma.

The power supply member 1 includes a power supply body 3, which is formed into an elongated rod, and a high conductivity metal layer 5, which is shaped in a substantially hollow cylinder and formed on the outer peripheral surface of the power supply body 3.

The power supply body 3 is formed from Ni, Al, Cu, an alloy containing any one of these metals, or the like. The power supply body 3 can have various shapes such as rod (pole), solid cylinder, cable, plate, woven string, and hollow cylinder-like shapes.

The high conductivity metal layer 5 is made of a material whose conductivity is higher than that of the power supply body 3 in an environment from room temperature to 900° C. For example, when the power supply body 3 is made of Ni, the high conductivity metal layer 5 is preferably formed from noble metal such as Au, Pt, or Rh.

Specifically, it is preferable that the volume resistivity of the high conductivity metal layer 5 at room temperature is not more than half of 6.8 μΩ·cm, which is the volume resistivity of Ni at room temperature. Moreover, it is preferable that the volume resistivity of the high conductivity metal layer 5 at 900° C. is not more than half of 45.5 μΩ·cm, which is the volume resistivity of Ni at 900° C. The thickness of the high conductivity metal layer 5 is preferably 2 to 30 μm and more preferably 10 to 30 μm. This makes it possible to efficiently flow 80% or more of skin current through the high conductivity metal layer 5 when high frequency voltage at 10 MHz or more is applied to the power supply body 3. The high conductivity metal layer 5 is formed on the surface of the power supply body 3 (the outer peripheral surface) by means such as plating, thermal spraying, or brazing.

As described above, in the power supply member 1, the high conductivity metal layer 5 with a conductivity higher than that of the power supply body 3 is formed on the surface of the power supply body 3. This allows part of the skin current flowing through the surface part of the power supply body 3 to flow through the high conductivity metal layer 5 when high frequency voltage is applied to the power supply member 1. Accordingly, the resistance of the power supply body 3 when the high frequency voltage is applied thereto is reduced, and the amount of heat generated by the power supply body 3 can be reduced. Furthermore, the reduction in the amount of heat generated inhibits degradation of the power supply member 1, so that an increase in the resistance of the power supply member 1 itself can be reduced and arbitrary plasma power can be generated.

[Second Embodiment]

Next, a second embodiment of the present invention is described. In this embodiment, the description is given of a power supply member including a high conductivity metal layer formed on the outer peripheral surface (on the surface side) of the power supply body with an diffusion preventing metal layer interposed therebetween.

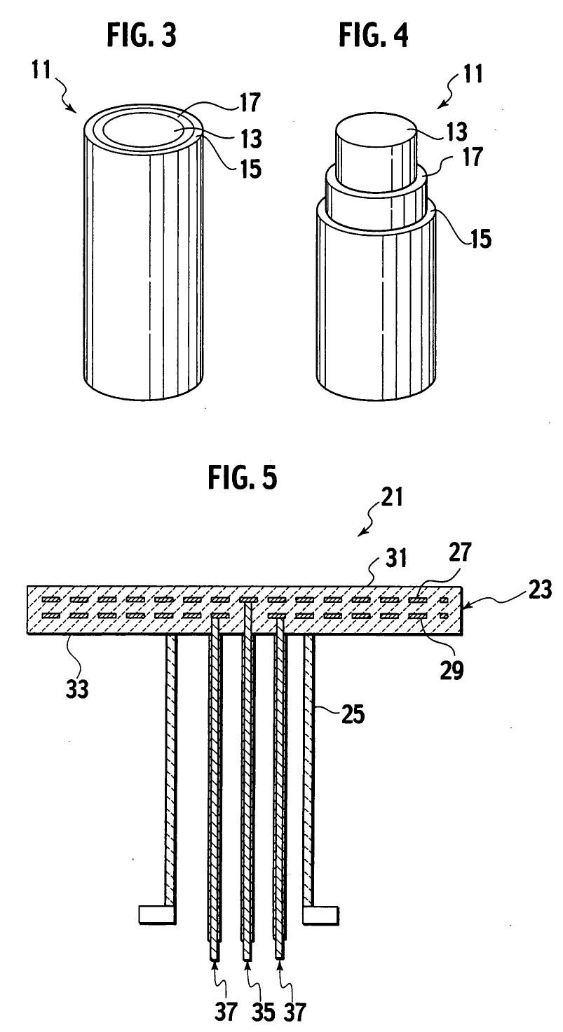

FIG. 3 is a perspective view of a power supply member according to the second embodiment of the present invention, and FIG. 4 is a perspective view showing the power supply member of FIG. 3 with upper part of the high conductivity metal layer and diffusion preventing metal layer omitted.

A power supply member 11 according to this embodiment is formed into an elongated rod and includes a power supply body 13, an diffusion preventing metal layer 17, and a high conductivity metal layer 15. The power supply body 13 is arranged in the radial center of the power supply member 11. The diffusion preventing metal layer 17 is formed on the outer peripheral surface of the power supply body 13. The high conductivity metal layer 15 is formed on the outer peripheral surface of the diffusion preventing metal layer 17. The diffusion preventing metal layer 17 is formed between the power supply body 13 and high-conductivity metal layer 15.

The diffusion preventing metal layer 17 is made of metal which hardly diffuses into the power supply body 13 and preferably made of, for example, Cr, Rh, or the like. Moreover, the thickness of the diffusion preventing metal layer 17 is preferably 0.1 to 5 μm. The diffusion preventing metal layer 17 is formed on the surface of the power supply body 13 by plating, thermal spraying, brazing, or the like. The conductivity of the diffusion preventing metal layer 17 may be lower than that of the power supply body 13. The high conductivity metal layer 15 is formed on the surface of the diffusion preventing metal layer 17 by plating, thermal spraying, brazing, or the like.

As described above, with the power supply body 11 of this embodiment, the diffusion preventing metal layer 17 is provided between the power supply body 13 and the high conductivity metal layer 15, which can prevent the high conductivity metal layer 15 from diffusing to the power supply body 13 in a high temperature environment. It is therefore possible to allow part of the skin current flowing through the surface part of the power supply body 13 to flow through the high conductivity metal layer 15 even in the high temperature environment and further reduce the amount of heat generated by the power supply body 13.

[Third Embodiment]

Next, a description is given of a substrate heater as a plasma processing device according to a third embodiment of the present invention. The substrate heater of this embodiment includes the power supply member according to the aforementioned first or second embodiment.

FIG. 5 is a perspective view showing the substrate heater according to the third embodiment of the present invention.

This substrate heater 21 includes a ceramic base 23, which is formed into a disc, and a shaft 25, which is attached to a rear face 33 of the ceramic base 23 and supports the ceramic base 23. Within the ceramic base 23, a high frequency electrode 27 and a resistance heating element 29 are buried. This high frequency electrode 27 is disposed above the resistance heating element 29.

The upper surface of the ceramic base 23 is formed as a substrate placement surface 31 on which a substrate (wafer) is placed and held. The resistance heating element 29 is heated to heat the substrate on the substrate placement face 31. The ceramic base 23 is preferably formed from AlN, SN, SiC, alumina, or the like.

The high frequency electrode 27 is supplied with high frequency current from later described power supply members 35 and 37 to generate plasma.

The high frequency electrode 27 can have various shapes such as mesh and plate-like shapes. The high frequency electrode 27 may be formed by printing conductive paste on the ceramic base 23. The high frequency electrode 27 is conductive and can be formed from a conductive high melting point material, for example, such as W, Mo, WMo, or WC.

The resistance heating element 29 can have various shapes such as mesh and coil-like shapes. The resistance heating element 29 may be formed by printing conductive paste on the ceramic base 23. The resistance heating element 29 is conductive and can be formed from a conductive highmelting point material, for example, such as W, Mo, WMo, or WC.

The shaft 25 is formed into a hollow cylinder and can be made of ceramic, metal, or the like.

Within the shaft 25, the high frequency electrode power supply member 35 and resistance heating element power supply member 37 are provided.

The high frequency electrode power supply member 35 is joined to the high frequency electrode 27 by means such as calking, welding, brazing, or soldering. The resistance heating element power supply member 37 is joined to the resistance heating element 29 by means such as calking, welding, brazing, or soldering.

Each of these high frequency electrode power supply member 35 and resistance heating element power supply member 37 is the power supply member 1 or 11 described in the above first and second embodiments.

Specifically, the high frequency electrode power supply member 37 may be either the power supply member with the high conductivity metal layer 5 formed on the outer peripheral surface of the power supply body 3 (see FIGS. 1 and 2) or the power supply member with the high conductivity metal layer 5 formed on the outer peripheral surface of the power supply body 3 with the diffusion preventing metal layer interposed therebetween (see FIGS. 3 and 4).

Furthermore, the resistance heating element power supply member 37 may be either the power supply member with the high conductivity metal layer 5 formed on the outer peripheral surface of the power supply body 3 (see FIGS. 1 and 2) or the power supply member with the high conductivity metal layer 5 formed on the outer peripheral surface of the power supply body 3 with the diffusion preventing metal layer interposed therebetween (see FIGS. 3 and 4).

The present invention is not limited to the above embodiments and can be variously modified. For example, in the substrate heater 21 as the plasma processing device, the resistance heating element 29 is buried in the ceramic base 23, and the shaft 25 is joined to the rear face 33 of the ceramic base 23. However, the resistance heating element 29 may be not provided, or the shaft 25 may be not provided.

### EXAMPLES

Next, the present invention is more specifically described through examples.

### Example 1

As Example 1, the power supply member 11 shown in FIGS. 3 and 4 was produced.

Specifically, first, power supply bodies composed of Ni rods 200 mm long were prepared. Next, as the diffusion preventing metal layer, Rh was plated over the outer peripheral surface of each power supply body to a thickness of 0.5 μm. As the high conductivity metal layer, Au is plated over the outer peripheral surface of the diffusion preventing metal layer to a thickness of 20 μm, thus obtaining power supply members according to Example 1.

### Example 2

As Example 2, the power supply member 1 shown in FIGS. 1 and 2 was produced.

Specifically, first, power supply bodies composed of Ni rods 200 mm long were prepared. Next, Au is plated over the outer peripheral surface of each power supply body to a thickness of 20 μm without the formation of the diffusion preventing metal layer, thus obtaining power supply members according to Example 2.

### Examples 3 to 6

Power supply members according to Examples 3 to 6 were produced according to Table 1 below in a similar procedure to those of Examples 1 and 2.

TABLE 1

| | | Example | Example | Example | Example | Example | Example | Comparative |
|---|---|---|---|---|---|---|---|---|
| | | 1 | 2 | 3 | 4 | 5 | 6 | Example 1 |
| High | Material | Au | Au | Au | Au | Au | Au | Not formed |
| Conductivity | Thickness | 20 | 20 | 2 | 10 | 30 | 20 | — |
| Metal Layer | [μm] | | | | | | | |
| Diffusion | Material | Rh | Not formed | Rh | Rh | Rh | Cr | Not formed |
| Preventing | Thickness | 0.5 | — | 0.5 | 0.5 | 0.5 | 0.5 | — |
| Metal Layer | [μm] | | | | | | | |

| | | | | | | | |
|---|---|---|---|---|---|---|---|
| Resistance | 78 | 66 | 332 | 183 | 71 | 85 | 796 |
| (13.56 MHz)[mΩ] | | | | | | | |
| Peripheral Member Damage | ◯ | ◯ | ◯ | ◯ | ◯ | ◯ | X |

### Comparative Example 1

As Comparative Example 1, a power supply member composed of a Ni rod 200 mm long was prepared. This power supply member was not provided with the diffusion preventing metal layer and high conductivity metal layer.

[Evaluation 1 (Resistance at Room Temperature)]

The resistance of the power supply members of Examples 1 to 6 and Comparative Example 1 was measured when high frequency voltage at 13.56 MHz was applied thereto.

In Example 3, only by forming the high conductivity metal layer of Au with a thickness of 2 μm on the diffusion preventing metal layer, the resistance R thereof when high frequency voltage at 13.56 MHz was applied thereto could be reduced to half of that of Comparative Example 1, in which the high conductivity metal layer was not formed. Moreover, the equation (2) described in the above description of the related art revealed that the amount of heat generated by the power supply member of Example 3 when high frequency voltage was applied thereto could be reduced to half of that of Comparative Example 1.

Moreover, Example 4 revealed that when the thickness of the high conductivity metal layer was set to 10 μm, the resistance R when high frequency voltage at 13.56 MHz was applied thereto could be reduced to 20% or less of that of Comparative Example 1. Examples 1, 2, 5, and 6 similarly revealed that when the thickness of the high conductivity metal layer was set to 20 μm or more, the resistance when the high frequency voltage at 13.56 MHz was applied thereto could be reduced to 10% or less of that of Comparative Example 1.

[Evaluation 2 (Volume Resistivity of Power Supply Member Having been Held at 1000° C.)]

Moreover, as shown in Table 2 below, after the power supply members were held in the atmosphere at 1000° C. for 4 hours, resistance R thereof when high frequency voltage at 13.56 MHz was applied was measured in a similar way to that of Evaluation 1.

TABLE 2

| | Example | Example | Example | Example | Example | Example | Comparative |
|---|---|---|---|---|---|---|---|
| | 1 | 2 | 3 | 4 | 5 | 6 | Example 1 |
| Resistance | 85 | 530 | 343 | 226 | 76 | 92 | 820 |
| (13.56 MHz)[mΩ] | | | | | | | |
| Peripheral Member Damage | ◯ | ◯ | ◯ | ◯ | ◯ | ◯ | X |

As apparent from Table 2, holding the power supply member with the diffusion preventing metal layer not formed in the high temperature environment significantly increased the volume resistivity. This is thought to be because Au of the high conductivity metal layer diffused to the power supply body. It was therefore revealed that providing the diffusion preventing metal layer for the power supply member prevented Au of the high conductivity metal layer from diffusing to the power supply body and the resistance hardly varied even when the power supply member was held in the high temperature environment.

Examples 1 and 6 revealed that even when the material of the diffusion preventing metal layer was Cr, a similar effect to the case of Rh could be obtained.

[Evaluation 3 (Damage Level of Peripheral Member)]

Furthermore, using the power supply members which had been and which had not been held at 1000° C., plasma processing devices were produced. Then, it was verified whether peripheral members were damaged when high frequency voltage of 2000 W at 13.56 MHz was applied to the power supply member. The results thereof are shown in Tables 1 and 2. Cases in which the peripheral members were damaged are indicated by x, and cases in which the peripheral members were damaged are indicated by o.

As shown in these Tables 1 and 2, in Comparative Example 1, the power supply members which had not been and which had been held in high temperature atmosphere at 1000° C. both damaged the peripheral members when high frequency voltage was applied thereto.

As shown in Example 2, when the diffusion preventing metal layer was not provided, the power supply member which had not been held in high temperature atmosphere at 1000° C. did not damage the peripheral members when high frequency voltage was applied, but the power supply member which had been held in the high temperature atmosphere at 1000° C. damaged the peripheral members. This revealed that providing the diffusion preventing metal layer was preferable.

1. A plasma processing device, comprising:
a base including an electrode to which high frequency voltage is applied: and
a power supply member supplying high frequency current to the electrode, wherein
the power supply member includes a power supply body and a high conductivity metal layer which is formed on a surface side in the power supply body and includes a conductivity higher than that of the power supply body.

2. The plasma processing device according to claim 1, wherein
an diffusion preventing metal layer preventing the high conductivity metal layer from diffusing to the power supply body is provided between the power supply body and the high conductivity metal layer.

3. The plasma processing device according to claim 1, wherein
the base includes a resistance heating element, the plasma processing device further comprising the power supply member which supplies current to the resistance heating element.

4. The plasma processing device according to claim 1, wherein
thickness of the high conductivity metal layer is 2 to 30 μm.

5. The plasma processing device according to claim 1, wherein
the power supply body of the power supply member is made of at least one of Ni, Al, Cu, and alloys containing Ni, Al, or Cu.

6. The plasma processing device according to claim 1, wherein
the high conductivity metal layer is formed from noble metal or an alloy containing the noble metal.

7. The plasma processing device according to claim 1, wherein
the diffusion preventing metal layer is formed from at least one of Cr and Rh.
